(19) United States
(12) Patent Application Publication
(10) Pub. No.: US 2024/0356928 A1
(43) Pub. Date: Oct. 24, 2024

(54) CONDO SOCIAL NETWORK TO MITIGATE OWNER AND INVESTOR RISKS OF MULTI-UNIT RESIDENTIAL, COMMERCIAL AND INDUSTRIAL REAL ESTATE PROPERTIES

(71) Applicant: Natalia Goryacheva, Toronto (CA)

(72) Inventor: Natalia Goryacheva, Toronto (CA)

(21) Appl. No.: 18/304,291

(22) Filed: Apr. 20, 2023

(51) Int. Cl. H04L 9/40; G06Q 50/00; G06Q 50/16

(52) U.S. Cl. CPC H04L 63/105; G06Q 50/01; G06Q 50/163; H04L 63/102

(57) ABSTRACT

A multi-unit building communication network and method that is operable to control and facilitate communications and outputs for individuals affiliated with a building such as but not limited to a condominium building. The invention includes a software that facilitates communication between users wherein the users are assigned to a category and sub-category wherein this assignment dictates their communication privileges during utilization of the building management method. The category assignment of the present invention is based on the physical address and/or building identity. The sub-category assigned to the users of the present invention is a classification based on their affiliation with the building such as but not limited to owner or property manager. The invention provides restriction or access between the users based on their sub-category. The database of the invention provides collection of operational data gathered during communications between users and executes an analysis thereof in order to identify opportunities for financial and non-financial improvements of multi-unit properties.

### FIELD OF THE INVENTION

The present invention relates generally to communication networks for real estate, more specifically but not by way of limitation, a method facilitated by a software application wherein the method of the present invention facilitates social and professional communication between different categories of individuals that either reside or manage a multi-unit building. Social networks comprising methods, and organization of users based on verified user role, property address, privileges and restrictions for more efficient user (more specifically but not by way of limitation, owner, resident, manager, service provider etc.) communications, more transparent information, and a higher financial efficiency of multi-unit residential, commercial and industrial properties.

### BACKGROUND

Online social networks have become an integral part of the lives of a majority of society in developed countries. Social networks enable individuals to connect, communicate, and share information. The popularity of social networks has also allowed for the creation of online communities that facilitate communication between individuals about common interests, exchange ideas, and find advice. Social network communities have become an important source of support and information for many individuals. There are many different types of online social networks wherein these online networks typically focus on a particular genre or target a specific industry. By way of example but not limitation, LinkedIn is an online social network that is focused on the professional careers of its users and promotes networking amongst. The reach of online social networks can be specific to a certain geography or have an expansive global footprint. Most social networks are residential address agnostic and do not provide any features focused on a specific geographic location.

One deficiency with most online networks is their inability or lack of organizing the users. No categorization of the users is executed and as such their lacks a benefit that could be delivered with a categorization of users in order to identify either a specialty or designate an authority for a certain entity. Organizing users into categories and sub-categories based on parameters such as but not limited to verified address and role/title would provide significant benefit in driving efficiency for communications, improved financial and emotional well-being of owners and residents. By way of example but not limitation, for a multi-unit building identification of individuals such as owners, managers and investors could drive enhanced communication and as such faster problem solving. Furthermore, an improved transparency for the categories of these individuals would facilitate an improved overall experience. By way of example but not limitation, an ability to facilitate communication on issues such as but not limited to financial and non-financial amongst individuals in a common building. Current technology further fails to facilitate communication between similar categories of individuals that reside in different buildings but may experience the same issue or have a similar concern.

Accordingly, there is a need for a method that facilitates social communication between categories and sub-categories of individuals that are either residents or professionally associated with multi-unit buildings.

### SUMMARY OF THE INVENTION

It is the object of the present invention to provide a method of facilitating social communication and improvement of relationships of individuals in the same or similar buildings via a software application wherein the present invention implements assigning categories and sub-categories to users.

Another object of the present invention is to provide a communication network and method operable to facilitate communication of a multitude of individuals associated with multi-unit buildings wherein the present invention employs address verification and further utilizes address to permit communication of users that have the same category and sub-category based on a role in the building.

A further object of the present invention is to provide a method of facilitating social communication and improvement of relationships of individuals in the same or similar buildings via a software application wherein the present invention provides restriction of communication between some categories and sub-categories of individuals.

Yet a further object of the present invention is to provide a communication network and method operable to facilitate communication of a multitude of individuals associated with multi-unit buildings wherein a user's privileges are based on their category or sub-category.

Still another object of the present invention is to provide a method of facilitating social communication and improvement of relationships of individuals in the same or similar buildings via a software application wherein the present invention facilitates communication between the same categories of individuals across different buildings.

An additional object of the present invention is to provide a communication network and method operable to facilitate communication of a multitude of individuals associated with multi-unit buildings wherein the present invention places restrictions on communications between some categories and sub-categories of individuals.

Yet a further object of the present invention is to provide a method of facilitating social communication and improvement of relationships of individuals in the same or similar buildings via a software application wherein the present invention permits inquiries from non-users of the software to specific categories and/or sub-categories of users.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a schematic diagram of process flow between sub-categories across three commerical buildings; and

FIG. 2 is a schematic diagram of process flow between sub-categories across multiple multi-unit residential buildings; and

FIG. 3 is a flowchart of an exemplary method of the present invention; and

FIG. 4 is a flowchart of an exemplary process for a group or subgroup selection choice to transmit a message; and

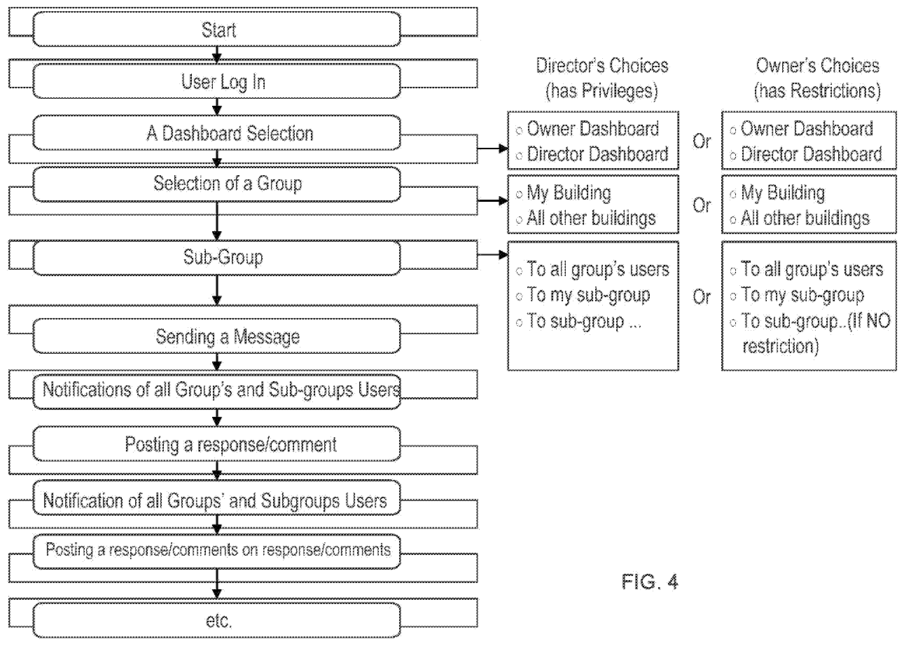

FIG. 5 is a flowchart of an exemplary process of the present invention to transmit a complaint, categorize the complaint and response process.

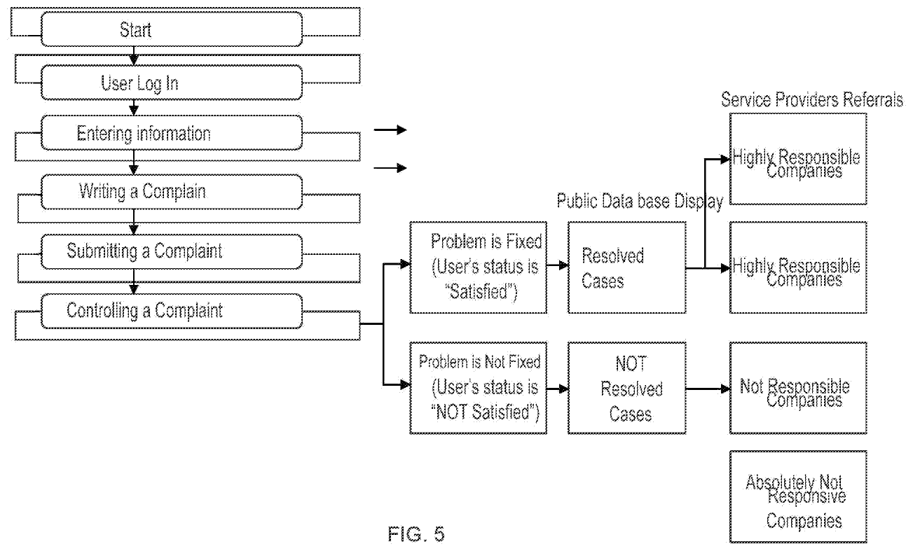

### DETAILED DESCRIPTION

Referring now to the drawings submitted herewith, wherein various elements depicted therein are not necessarily drawn to scale and wherein through the views and figures like elements are referenced with identical reference numerals, there is illustrated multi-unit building communication network and method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given details described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

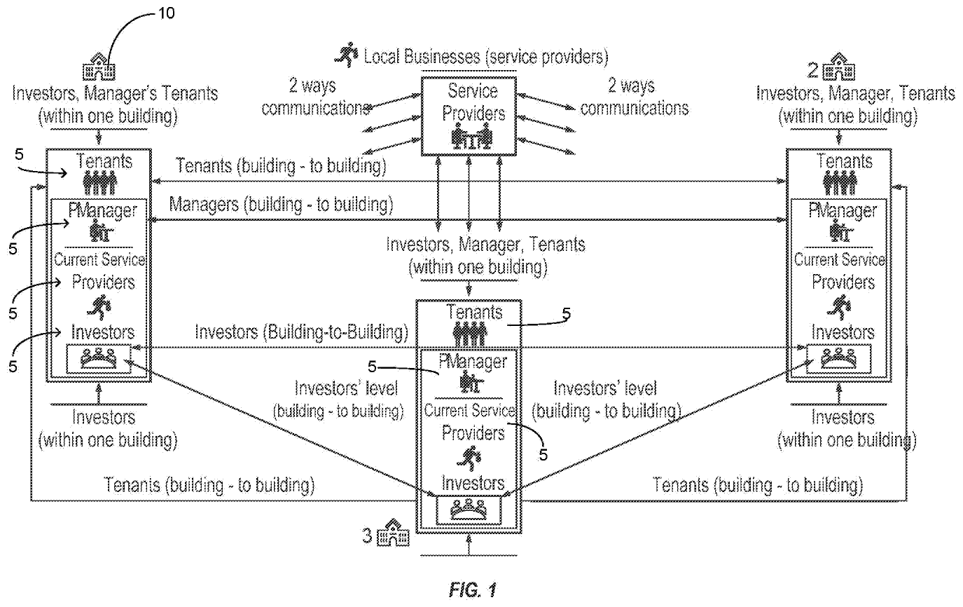

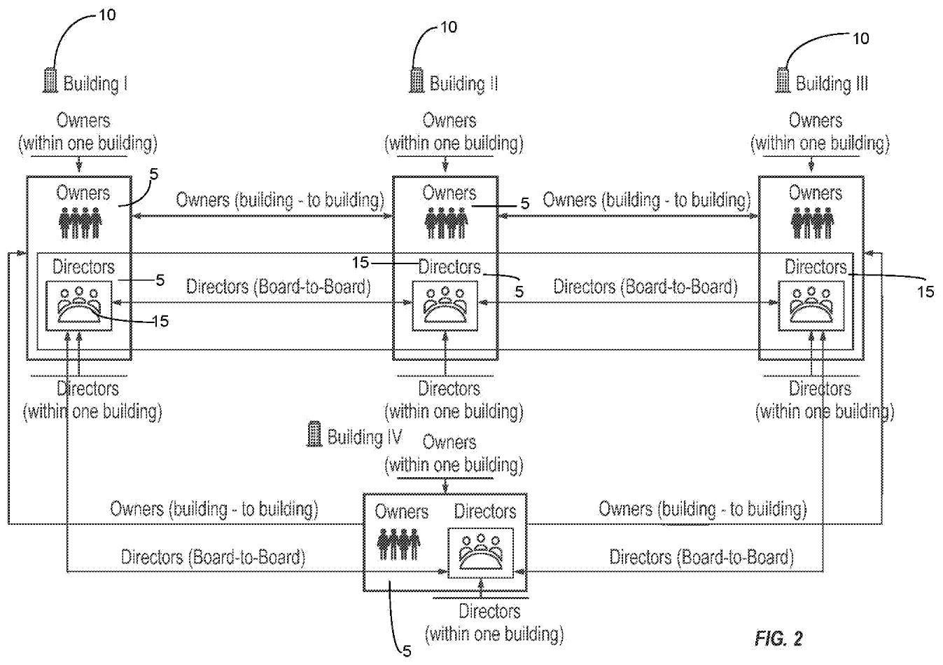

Referring in particular to the Figures submitted herewith, the multi-unit building communication network and method 100 facilitates a process flow for individuals associated with a building or a plurality of building as it pertains to residential and management requirements and needs. It should be understood within the scope of the present invention that the multi-unit building communication network and method 100 could be applied to any type of commercial, industrial or residential building. It should be further understood within the scope of the present invention that the software providing operation of the multi-unit building communication network and method 100 could be employed as a software application on a smart phone or similar device or be a website accessible by computing devices. Referring in particular to FIG. 1, the sub-categories 5 are diagrammed therein illustrating communication protocols permitted by the software of the multi-unit building communication network and method 100. The sub-categories 5 are individuals who are either personally or professionally affiliated with a building 10. As discussed herein there are different identities of sub-categories which are comprised of the following: investor, property manager, tenant, owner, service provider and potential service provider. The ensuing discussion will provide information on the process protocols facilitated by the software of the present invention that provides control of parameters such as but not limited to communication privileges. As illustrated herein in FIG. 2, an exemplary communication privilege facilitated by the multi-unit building communication network and method 100 is shown therein. FIG. 2 illustrates management of protocols permitted between buildings 10 and the sub-categories 5 affiliated with those buildings 10. By way of example but not limitation, sub-categories 5 of the same title/position as it regards to affiliation with the building, e.g., directors 15 have the communication privilege provided by the software of the present invention to communicate with additional directors and owners. As will be further discussed herein, the present invention provides different communication privileges to different sub-categories 5 permitting some to have two-way communication, others to be unable to communicate with certain sub-categories and others having only one-way communication privileges with other sub-categories.

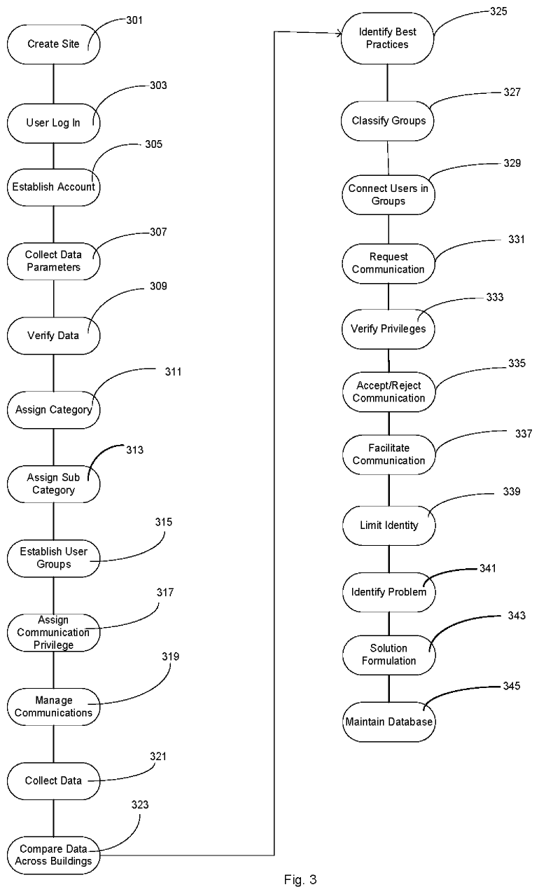

Referring in particular to FIG. 3, an exemplary method of the present invention is diagrammed therein. It should be understood within the scope of the present invention that the order of the process outlined in FIG. 3 is exemplary only and it is contemplated that the order could be altered and/or include or omit some of the steps diagrammed therein. In step 301, the owner/operator of the multi-unit building communication network and method 100 publishes the website providing the graphical interface to utilize the software that facilitates the multi-unit building communication network and method 100. It should be understood within the scope of the present invention that the software providing operation of the multi-unit building communication network and method 100 could be made available via a website or be provided as a software application that is downloaded to a portable computing device. Step 303, a user will login to the software application and in Step 305 the user, if new, will establish an account with the building management method 100. In step 307, the user will enter parameters about themselves wherein these parameters are collected in the software database of the multi-unit building communication network and method 100. The parameters collected can include but are not limited to name, age, building information, affiliation with the building. The parameters collected are employed to assign a category and sub-category to the individual as is discussed herein.

In step 309, the parameters entered by the user are verified utilizing necessary processes so as to ensure the user having entered the information is accurately represented by the entered parameters. In step 311, the software of the present invention assigns a category to the user. The category is address and building specific. By way of example but not limitation, if the user is associated with a condominium building, the name of the building and address are utilized to create a category identity that is assigned to the user in order to assist in establishment of an affiliation with a particular building. In step 313, the software subsequently assigns the user a sub-category wherein the sub-category specifically identifies the role of the user related to the building for which information was collected. It is contemplated within the scope of the present invention that the following sub-categories are assigned to a user: investor, property manager, tenant, owner, service provider and potential service provider. As is further discussed herein, based on the sub-category classification of a user, a communication protocol privilege is controlled by the software in order to facilitate and manage communications between all users of the building using method 100.

Step 315, the software will establish user groups for all users wherein the user groups are established utilizing the category and sub-category assigned to each user. In step 317, employing the category and sub-category of each user, as well as the user group assigned thereto, the software of the present invention will assign communication privileges and restrictions for each user. These communication privileges and restrictions control the ability for a user to communicate with other users based on their category and sub-category. Byway of example but not limitation, the software may provide restrictions for tenants or owners communicating directly with an investor or a potential service provider. Additionally, the software controls communication flow permitting either one-way and/or two-way communication between individuals having certain sub-categories. Step 319, the software provides management of communications between users belonging to a user group being assigned to a category and a subcategory. These communications are implemented utilizing audio data, video data or written data and the flow path of the communication is permitted or restricted based on the category and sub-category of the user.

In step 321, the software of the present invention employs a database that records, stores and classifies all of the communication data being conducted within the system of the present invention. Step 323, the software of the present invention can be employed to compare similarly classified data across multiple buildings. Data analysis is conducted on parameters such as but not limited to delivery parameters and costs for service providers. Furthermore, data analysis can be conducted on HVAC data or other building operational data that can be employed to provide operational visibility for users affiliated with a building and as such a category. It should be understood within the scope of the present invention that data analysis could be implemented on all data types stored within the database of the present invention. In step 323, a user having a sub-category such as but not limited to investor or property manager could review the data analysis so as to compare project outcome results for a single building or data across multiple buildings. It should be understood within the scope of the present invention that the data analyzed could be but is not limited to building operational data, service metrics, tenant or owner inputs or other data pertaining to a building or buildings. Step 325, the user conducting the review of the data in conjunction with the software outputs identifies a best practice as determined by the data set. The best practice can then be employed either in the same building or other buildings so as to drive improvement in the metrics for which the data represented.

In step 327, the software will provide classification to user groups based on parameters such as but not limited to physical address and sub-category of the users within the group. By way of example but not limitation, the software will classify an owners' group wherein the owners are all affiliated with the same building. Step 329, ensuing classification of the user groups, the software will provide the users within the same user group an identity of all of the users in the group. The identity provided is done so to protect the anonymity of the user but facilitate communication between the users belonging to the same user group. It should be understood within the scope of the present invention that the user groups could be constructed so as to consist of users within the same building or the user group could be comprised of user of the same sub-category from different buildings. In step 331, in an exemplary utilization of a user group, a user within a user group requests communication with another user. Step 333, the software will verify the communication privileges and restrictions of the user requesting the communication to ensure that the communication is permitted within the rules of the present invention. In step 335, the software of the present invention will accept or reject the communication request of the user. If rejected the user will be notified that the communication request will not be transmitted by the system. Step 337, ensuing review and acceptance of the communication requests, the software of the building management method 100 will transmit the communication to the desired user group wherein a single user or multiple users will receive the communication. Step 339, as discussed herein, the requesting user will have their identity withheld and the receiving user(s) will be aware of the sub-category of the user group, a sender first name and some other identifier such as but not limited to an alias username. In step 341, a problem or need is identified through communications between users in the user groups. The data transferred between the users in the user groups is captured for data analysis thereof. Step 343, utilizing the data, a solution or suggestion for improvement is formulated for the problem/need identified in the content of the communications between the users in the user groups. It should be understood within the scope of the present invention that the problem-solution cycle is repeated during utilization of the multi-unit building communication network and method 100 and can encompass a wide variety of matters as it pertains to buildings to which users are affiliated therewith. In step 345, the software of the multi-unit building communication network and method 100 maintains all communication data as well as solutions formulated in the database and makes available to verified users for subsequent review thereof.

The ensuing discussion of the multi-unit building communication network and method 100 listed hereinafter is provided to offer additional information regarding the building management method 100. This subsequent matter provides some redundancy to the aforementioned material and further provides greater specificity to some areas thereof.

The following description created for the purposes of explanations and are supplemental to the foregoing discussion of the present invention. Disclosed embodiments relate to a present invention and a method of creating and managing an online social network having a plurality of multi-unit residential as well as commercial or industrial buildings. The disclosure of present invention, apparatus and methods of the present invention are created to describe communication networks for users owning residential buildings. To organize user account into categories the present invention may request a document from a user, that confirms user role and/or ownership of that property at a particular address. The present invention further assigns the user to the selected building and grant the user access to communications based on user role in the selected building. In an embodiment, a computer-implemented method comprises creating and storing in computer data storage condominiums/HOAs/apartments database collected by an appropriate software. When a user is adding an address that is not in the database it activates database of an appropriate city and update it. So, that original database is developing automatically based on user-generating input. When a user added a new address, the address is verified by the present invention and uploaded thereinto. The user account relates to a particular address of the building, which stipulates in the system of the present invention that the receives access to communication in the group and a sub-category associated with a particular address and user role.

Using a computer, for each building among the plurality of buildings, determining all users associated with a particular address and connecting them into one group. Based on a user role, previously verified, the present invention assigns a user to a user sub-category that has built-in list of privileges and restrictions. Using the computer associated with a sending user of a group, the sender initiates communication such as but not limited to text, video or audio. specifying another user group, selecting a particular user group from the list of multi-unit buildings. Sending a message, a sending user activates data base update that automatically sends out notifications to the users of both user categories, a group of users related to a sender and a group of receiving users that was selected by a sender.

Consistent with a disclosed embodiment, a computer-implemented method is provided for managing an online social network having a plurality of multi-unit buildings. The method includes receiving an address and a user role document from user, verifies address selecting a right user group, owners of a multi-unit building, from the plurality of buildings based on exact the address. The method further includes assigning the user to the selected sub-category based on a role in the building and granting the user access to communications by users assigned to the selected user group and sub-category. Consistent with another disclosed embodiment, a server is provided for managing an online social network having a plurality of buildings. The server includes a processor and a memory storing instructions executable by the processor to provide the method discussed above. Consistent with yet another disclosed embodiment, a tangible computer-readable storage medium is provided storing instructions configured to execute the method discussed above.

The present invention delivers communication protocols and methods that assists in resolving at least three major problems related with a collective ownership in residential, commercial, and industrial buildings: First, absence or deficiency of consolidated comparable information and benchmarks. How other buildings' owners/investors spend less and maintain the building and properties market values perfectly. What is the best practice in financial efficiency and high quality of buildings maintenance and management. Secondly, absence or not effective communications between owners/investors and other sub-categories of users. There is no opportunity to know the contact information of people that own/invest/or rent similar properties. There was no network that allowed to get in touch with the neighbors of the same building in private (not showing a contact information) and independent network without property management control. Lastly, low financial efficiency that is not satisfied to owners/investors' expectations. Similar residential and commercial buildings might have a big difference in financial efficiency because of management deficiencies.

The network that connects people that lives in the same building has a lot of advantages because it connects people that share the same problems living/or investing in the same building. And considering that such multi-unit buildings are usually managed by property management companies. There is a high risk of conflict of interest between owners/investors that pay the money and a management company that has fiduciary responsibility. And in such situation, property owner investors not always can express their concerns and opinions related to low quality of management services and prices if owners/investors communication is organized based on software that is controlled by property management. The present invention facilitates transparency of information for all users. By way of example but not limitation. Residential properties owners, tenants, directors, commercial and industrial properties investors, current and potential service providers can exchange with information to make informed decisions. Facilitating contact with other buildings' owners, directors, tenants, and other user categories can exchange with opinions, experiences, references on service providers and arrange mutual projects and contracts to get better prices and for property managers and tenants of commercial and industrial buildings such networks might be helpful in day-to-day building management. Organizing effective communications assists owners, investors to be connected to have an opportunity to discuss owners/investors problems inside of buildings with the same building owners, and the same for directors and between buildings between owners/or investors of different buildings and between different condominiums' boards directors and between other user sub-categories. There are private communications, no detailed contact information, just first name is disclosed. The network is independent, secure, not controlled by any parties. So, all users can express their opinions, complaints, can get urgent help and advice. Providing influence the building management efficiency so as to reduce spend and attain more services.

Financial efficiency might be improved through better and timely information about best service companies, prices, communication and influencing to multi-unit buildings management. Disclosed embodiments relate to a present invention and methods of managing an online social network having a plurality of buildings and grouping based on verified address and sub-categories based on user roles related to those buildings. The present invention may receive a location from a user, verifies address, and select a group, based on verified address, a multi-residential building from the plurality of buildings. The present invention may further assign the user to a particular sub-category and grant the user access to communications by the role of that user in that building (owner, director—for residential and investor, tenant, property manager etc. —for commercial/or industrial building).

The present invention uses methods of user grouping and sub-categories to connect users into categories based on a multi-unit building address and into sub-categories based on a user role in a building. Intragroup (inside the building) and Extramural communication (between buildings) of residential properties. All users of residential buildings have the same types of sub-categories that indicate their roles in the buildings and define privileges and restrictions that are built in the present invention. So, each user belongs to a group of users that own/or live in the same building and to a sub-category that indicate the user's role in the building. All users of the same sub-category have the same privileges and restrictions applicable to that sub-category. So, when a user wants to engage in discussions with users of the same group (with users of the same multi-unit residential building) the present invention offers an appropriate choice of categories and subcategories for communications based on user address, roles, and related restrictions and privileges.

There are two sub-categories of networking users for residential buildings: Owner(sub-category one) and Director sub-category. Owner has a restriction. Users of that sub-category do not have access to communications of Sub-category two. Users that belong to sub-category two. Directors have privileges to have access to communications of sub-category one. Those privileges and restrictions applying to intragroup (inside the building) and extramural communications. Intragroup (inside the building) and Extramural communication (between buildings) of commercial/and industrial properties. All users of commercial/industrial buildings have the same types of sub-categories that indicate their roles in the buildings and define privileges and restrictions that are built in the present invention. So, each user belongs to a group of users that have investment/or lease/or service the building and to a sub-category that indicate the user's role in the building (investor, tenant, manager, current service provider). All users of the same sub-category have the same privileges and restrictions applicable to that sub-category. So, when a user wants to engage in discussions with users of the same group (with users of the same multi-unit commercial/or industrial building) the present invention offers an appropriate choice of categories and subcategories based on user address, roles, and related restrictions and privileges.

The present invention allows a user to share the problem as video/text or audio and receive urgent advice from network users that experienced the same situation or a user might post a complaint in video/audio or text and that complaint will be delivered to the responsible party and the response will be posted together with a complaint. Other users will be able to see the cases, see how similar situations might be resolved etc. Such publicity of complaints should increase responsibility of service providers, improve financial efficiency of residential and commercial property management, and owners and investors satisfaction. If a service provider is not responsive or does not want to correct the problem such service provider will be categorized appropriately to show its low quality for other users. User communication through knowledge base comprises a combination of two applications. The first application allows all categories of users to ask questions, and leave responses in text, video and audio format. The second application allows to analyze the database and to deploy the data page displaying it to public as a searchable knowledge base. Possible ways of communications: User-Database defined herein as when one user shares a problem through knowledge database page, and another user is giving advice, that advice is stored in the database and any user of that social network can access that database and utilize. User—Database Admin: defined herein as when one user shares the problem through knowledge database page and an administrative resource provides advice which is stored in database, and any user of that social network can access that database and utilize the advice. User—Database Admin—Professional—User: defined herein as when one user shares a problem through knowledge database page and an administrative resource provides advice, that advice is stored in the database, and any user of the social network can access the Database and utilize.

According to the first aspect of the present disclosure, a present invention provided comprising of: a) User accounts grouped using methods based on verified addresses. b) User communication is based on sub-categories based on user roles related to real estate properties, for residential: condo owner, condo director, for commercial and industrial: investor, property manager, tenant, current service provider, potential service provider. All parts of the present invention are connected in a system using described methods of user organization, based on verified address (one building address—one group) and a user role (one role one sub-category). Communication of users inside of the categories and outside of categories are based on user roles and embedded present invention of privileges and restrictions related to those sub-categories. The present invention is dedicated to improving informational transparency, effective communications, quality of property management services and financial efficiency of residential, commercial, and industrial properties, mitigating risks of conflict of interests, and protecting interests of the properties' owners/and investors.

According to the second aspect of the present disclosure, there are provided methods of user accounts grouping based on verified addresses of multi-unit residential (or commercial or industrial building) and based on a role in multi-unit residential (or commercial or industrial building). In one embodiment, a method verifies an address a user claimed. The present invention requests an appropriate collaborating document (tax bill, hydro bill, agreement etc.) to assign a particular user to a group. In another embodiment the present invention may request some documents to verify a user role in a multi-unit building or in commercial/or industrial building. The present invention requests an appropriate document (annual general meeting minutes, board minutes or similar documents) depending on location of condo community or commercial investor community. In some cases, a present invention verifies a user role based on official data of government bodies available to public. By way of example but not limitation, when a user signs up, the present invention requires a hydro bill to be submitted to verify a user address. If a user claims a status of a “condo director” in “sign up” form the present invention verifies a status of director based on official public data. No extra documents needed to verify this status. After verification, the user receives email invitation to sign in. All users having the same address assigned to the same group. The name of the group is a condominium, commercial building name or its address.

When a user sends a message to the same or another group. The name of the group and the name of user are displayed. But there is not any private information as last name, email, phone provided. So, a user can express his/her opinion free of fear to be blamed or harassed if his/her opinion is not aligned with a group's opinion. Access to communication sub-categories based on user roles in the property, There are the following communication sub-categories: owner, director sub-category, investor, property manager, tenant, current service providers, potential service providers. There are standard privileges and restrictions built in the networks. Some restrictions and privileges might be modified based on majority of commercial and industrial buildings requests, There is a combination of methods of knowledge base collection, processing, storing, and displaying to public web pages.

According to the third aspect of the present disclosure, there are provided user sub-category of communication, with privileges and restrictions organized based on: user role and restrictions and privileges built in the present invention of the network, and for commercial and industrial buildings user categories the list of restrictions and privileges might be modified. Upon registration, user role is verified, and user assigned to an appropriate group based on address and an appropriate user sub-category according to the role. Users can use, create, and share a wide range of content, including text, video, audio, graphs, and apps; make inquiries and recommendations, etc. The ability of an individual user to communicate with different categories of users, and access user categories content depends on the verified address and his/her role in the building. The prerequisite for registering a user is to provide their residential address, or a commercial or industrial building address and their role in the building, for verification. The address and the role must be accompanied by an official document including Tax bill, Utility bill or similar. A role of the residential building owner/or a commerical property inventor is confirmed with tax bill or Utility bill. But the role of the user (board director, property manager, tenant, or a local business owner (service provider must be confirmed with an appropriate official document defined by a network.

A social network account is an account of a registered user. Grouping of user accounts is organized based on the verified address (one building address—one group) and sub-categorizing is based on based on the user's role in the building. All users registered at the same address will have the same group. All users of a group who have the same verified Role share the same sub-category. Users registered at the same address of a residential building comprise the following roles: owner, tenant or director. Users registered at the same address of a commercial or industrial building comprise the following roles: tenant, property manager, investor, current service provider, local business (a potential service provider).

User restrictions and privileges. Communication sub-categorizing. User communications are organized based on categories and user roles in a multi—unit building. Internal Communications are organized to provide communications inside of the group (within the same building). For residential buildings: owner/or tenant sub-category, director sub-category. Restrictions: Directors have access to owner sub-category, but owners do not have access to Director sub-category. For commercial and industrial buildings: tenant sub-category, property management sub-category, investor sub-category. Restrictions: Investors have access to all communication sub-category. Property managers do not have access to investor sub-categories but have access to tenant sub-categories. Tenants do not have access to investor sub-categories and do not have access to property manager sub-categories. A user can communicate with other users: within the same group, or between categories, within the same user role, between user roles if a user has privileges to access to appropriate use sub-categories. There are no restrictions on the quantity of buildings (categories) to communicate with, but a user can select just one group at a time for communication or use a forum mode to communicate with all categories and all categories simultaneously. A user can communicate with users of the same category with no restrictions.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A multi-unit building communication network and method configured to facilitate communication between users affiliated with at least one building and at least one role in the building wherein the:
a software application is published so as to be accessible by users through computing devices at any time;
logging into the software application, wherein a multitude of users log into the software application to engage in use thereof;
creating an account, wherein each of the multitude of users creates an account, wherein account creation includes input of data parameters pertaining to a building and an identity of an affiliation with the building;
verifying the data parameters, wherein the software application executes verification of the data parameters input for each of the multitude of users;
assigning a category to each of the multitude of users, wherein a category assignment is assigned to each of the multitude of users and is operable to identify the building with which the users are affiliated;
assigning a sub-category to each of the multitude of users, wherein the sub-category is operable to define a role of the users with respect to the building;
assigning communication privileges and restrictions to each of the multitude of user, wherein the software application assigns the communication privileges and restrictions based on the category and sub-category of the user;
managing communications between the multitude of users, wherein the multitude of users communicate with each other as permitted by the software application;
collecting data from the communications that has transpired between the multitude of users, wherein the data is stored in a database;
analyzing the data, wherein the data is reviewed by an administrator and publishes it to be available to users so as to identify either a problem or a solution;
implementing a solution, wherein the data is utilized to identify a solution, wherein the solution addresses a need or problem at the at least one building.

2. The multi-unit building communication network and method configured to facilitate communication between different categories of users affiliated with at least one building as recited in claim 1, wherein the assignment of the category is based on the physical address of the multi-unit building.

3. The multi-unit building communication network and method configured to facilitate communication between users affiliated with at least one building as recited in claim 2, and further including a step of creating user groups, wherein the user groups are created based on the category and sub-category of users, wherein user groups comprise of users having a same sub-category and category assignment.

4. The multi-unit building communication network and method configured to facilitate communication between users affiliated with at least one building as recited in claim 3, wherein data is inputted into the software utilizing at least one of the following data types: audio data, video data or text data.

5. The multi-unit building communication network and method configured to facilitate communication between users affiliated with at least one building as recited in claim 4, and further including a step of comparing data from a first building to a second building, wherein data collected from the first building and second building are compared to identify differences therebetween.

6. The multi-unit building communication network and method configured to facilitate communication between users affiliated with at least one building as recited in claim 5, and further including a step of concealing an identity of a user participating in a user group.

7. The multi-unit building communication network and method configured to facilitate communication between users affiliated with at least one building as recited in claim 6, and further including a step of facilitating communication between users of a same category between many buildings, but between just two buildings at a time.

8. The multi-unit building communication network and method configured to facilitate communication between users affiliated with at least one building as recited in claim 7, and further including a step of restricting communication between a user having a first sub-category and a user having a second sub-category.

9. The multi-unit building communication network and method configured to facilitate communication between users affiliated with at least one building as recited in claim 8, and further including a step of requesting a communication with another user in a user group, wherein the software application provides acceptance or rejection of the communication request based on the sub-category of the user making the request.

10. The multi-unit building communication network and method configured to facilitate communication between users affiliated with at least one building as recited in claim 9, and further including a step of permitting communication only between users of the same sub-category or with other sub-categories based the list of privileges and restrictions applied to that particular sub-group of users.

11. The multi-unit building communication network and method configured to facilitate communication between users affiliated with at least one building as recited in claim 10, and further including a step of classifying the user groups, wherein the user groups are classified by the physical address of a building with which all of the users are affiliated.
